(19) United States
(12) Patent Application Publication
(10) Pub. No.: US 2017/0129680 A1
(43) Pub. Date: May 11, 2017

(54) FLEXIBLE ASSEMBLY WITH SPRAY FITMENT

(71) Applicant: Pouch Pac Innovations, LLC, Sarasota, FL (US)

(72) Inventor: R. Charles Murray, Sarasota, FL (US)

(21) Appl. No.: 15/350,461

(22) Filed: Nov. 14, 2016

Related U.S. Application Data
(60) Provisional application No. 62/253,720, filed on Nov. 11, 2015.

(51) Int. Cl. B65D 75/58; B05B 11/00; B65B 3/04; B65B 61/20; B65D 75/00; B65B 3/02

(52) U.S. Cl. CPC B65D 75/5883; B65D 75/008; B65B 3/02; B65B 3/04; B65B 61/20; B05B 11/0037; B05B 11/3011; B05B 12/002

(57) ABSTRACT

A flexible pouch assembly includes a flexible pouch with a front panel and a back panel with a spray fitment sealed between the front panel and the back panel. The spray fitment may include a base portion with an aperture providing a fluid passageway between the flexible pouch and a head portion of the spray fitment for which product may flow through and be sprayed from a spray nozzle of the spray fitment. The base portion may have a canoe shape that provides a smooth transition for a top or upper seam of the flexible pouch thereby ensuring a leak-tight seal between the flexible pouch and the spray fitment.

### CROSS-REFERENCE TO RELATED APPLICATIONS

The instant application claims priority to U.S. Provisional Application Ser. No. 62/253,720 filed on Nov. 11, 2015, the entirety of which is incorporated herein by reference.

### FIELD OF THE INVENTION

The instant application relates generally to flexible pouches, and more particularly, to flexible pouches having a spray fitment.

### BACKGROUND OF THE INVENTION

Containers such as bottles for holding cleaners, cleansers, etc. frequently include a spray mechanism for dispensing a product within the container. Such containers are frequently made of rigid plastic or metal materials and may not be environmentally friendly. Such containers may also take up additional space during transportation and when stored, e.g., when the container is half full with the product it occupies same space (volume) as when the container is completely full with the product. Accordingly, there exists a need for alternative, space saving and environmentally friendly containers with a dispensing apparatus.

### SUMMARY OF THE INVENTION

A flexible pouch assembly with a spray dispensing apparatus is provided. The flexible pouch assembly includes a flexible pouch with a front panel and a back panel, each of the front panel and the back panel having an upper edge, an opposed lower edge, and a side edge extending between the upper edge and the lower edge. The front panel is joined to the back panel with a bottom seam extending along the lower edge of the front panel and the back panel and a side seam extending along the side edge of the front panel and the back panel. A spray fitment is sealed between the front panel and the back panel of the flexible pouch. The spray fitment has a base portion disposed between the upper edge of the front panel and the back panel and a head portion with a spray nozzle extending from the base portion. A top seam extends along the upper edge of the front panel and the back panel and an outer surface of the base portion. The base portion includes an aperture providing a fluid passageway between the flexible pouch and the head portion for product to flow from within the flexible pouch into the head portion and through the spray nozzle.

In embodiments, the head portion has an internal threaded element and the base portion of the spray fitment includes a connector portion with an external threaded element that is complementary with the head internal threaded element such that the head portion is attached to the connector portion by contact between and rotation of the head portion relative to the base portion. That is, the head portion can be screwed onto the base portion.

In embodiments, the base portion has a canoe shape with a longitudinal axis extending along a length direction of the base portion and a transverse axis extending along a width direction of the base portion. A length of the canoe-shaped base portion is greater than a width of the canoe-shaped base portion. The base portion may also include a pair of tip portions oppositely disposed about the transverse axis and extending along the longitudinal axis and a finger portion extending from each of the pair of tip portions such that the top seam extends along each of the finger portions.

In embodiments, the flexible pouch assembly includes a tube extending from an aperture in the base portion into the flexible pouch. The head portion may have a handle for pumping product from the flexible pouch through the tube and out of the spray nozzle.

Additional features and advantages of the flexible pouch assembly described herein will be set forth in the detailed description which follows, and in part will be readily apparent to those skilled in the art of that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein and together with the description serve to explain the principles and operations of the claimed subject matter.

### BRIEF DESCRIPTION OF THE DRAWINGS

FIG. 1 schematically depicts a perspective view of a flexible pouch assembly with a spray fitment according to one or more embodiments disclosed and described herein;

FIG. schematically depicts a front view of the flexible pouch assembly shown in FIG. 1;

FIG. 3 schematically depicts a side view of the flexible pouch assembly shown in FIG. 1;

FIG. 4 schematically depicts a bottom view of the flexible pouch assembly shown in FIG. 1;

FIG. 5 schematically depicts a top view of the flexible pouch assembly shown in FIG. 1;

FIG. 6 schematically depicts a rear view of the flexible pouch assembly shown in FIG. 1;

FIG. 7 schematically depicts a side view of a spray fitment according to one or more embodiments disclosed and described herein;

FIG. 8 schematically depicts a cross-sectional view along section 8-8 shown in FIG. 7;

FIG. 9 schematically depicts a front view of the spray fitment shown in FIG. 7;

FIG. 10 schematically depicts a bottom view of a canoe-shaped base portion of a spray fitment according to one or more embodiments disclosed and described herein;

FIG. 11 schematically depicts a front view of the canoe-shaped base portion of the spray fitment shown in FIG. 10;

FIG. 12 schematically depicts a top view of the canoe-shaped portion of the spray fitment shown in FIG. 10; and

FIG. 13 schematically depicts a process a method for forming a flexible pouch with a spray fitment assembly according to one or more embodiments disclosed and described herein.

### DETAILED DESCRIPTION OF THE PREFERRED EMBODIMENTS

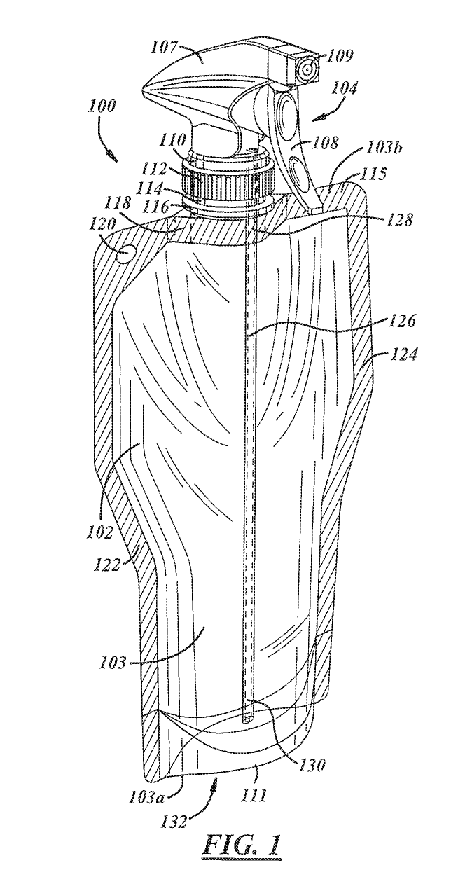

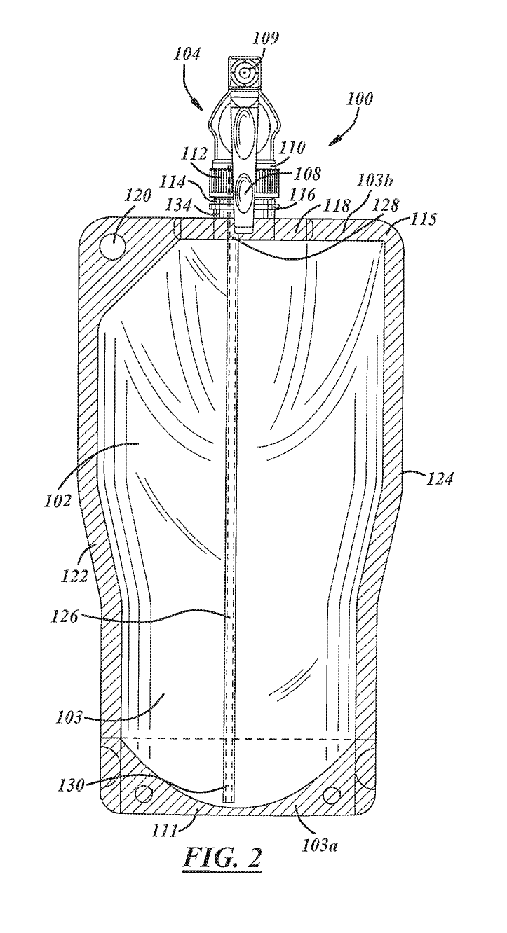

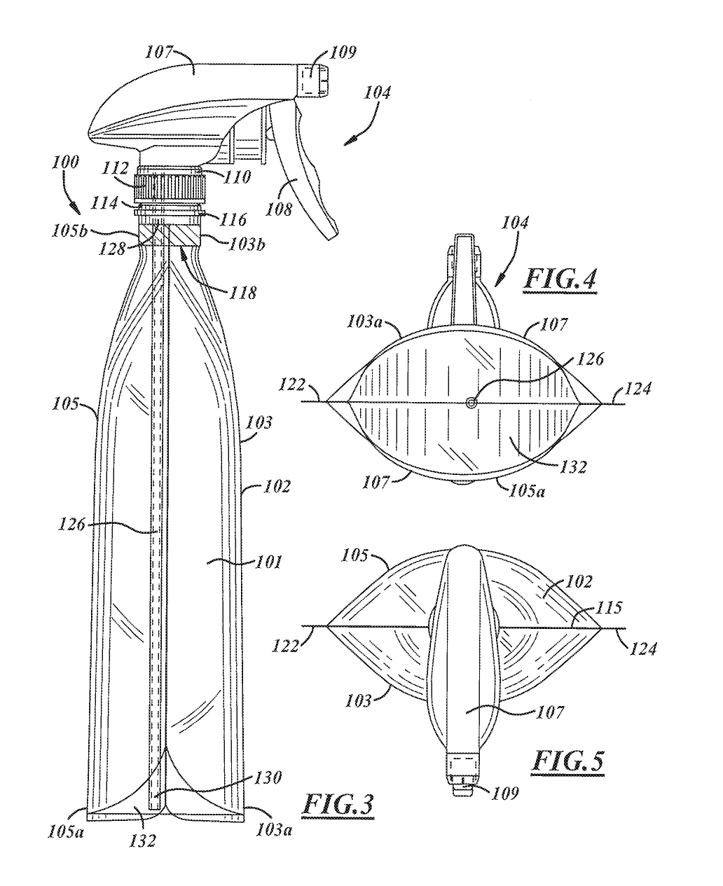

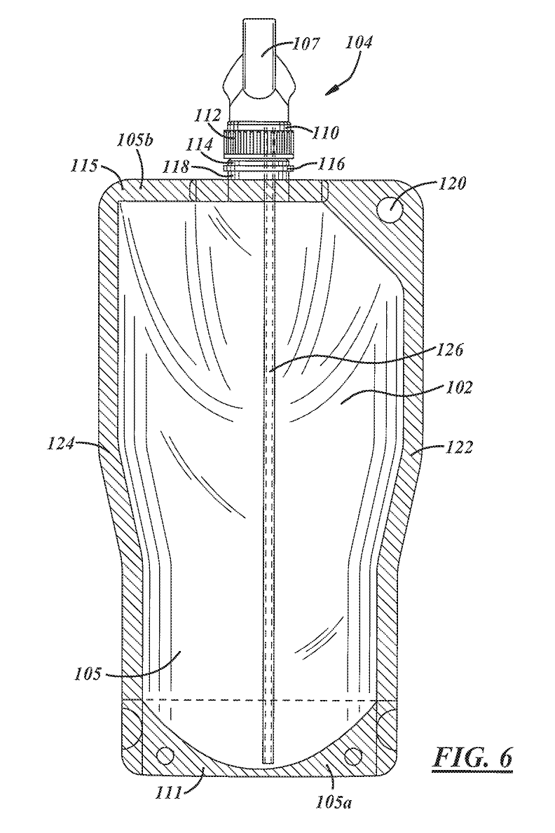

Referring to FIGS. 1-6, a flexible pouch assembly 100 having a flexible pouch 102 and a spray fitment assembly 104 is depicted. The flexible pouch 102 includes a front panel 103 and a back panel 105 with an interior 101 between the front panel 103 and back panel 105. The front panel 103 may be joined to the back panel 105 with a first side seam 122 and a second side seam 124. In embodiments, the front panel 103 may be joined to the back panel 105 with a single side seam, e.g., the front panel 103 and the back panel 105 may be formed from a single piece of sheet material with a fold to produce one side edge of the flexible pouch 102 and a side seam to produce another side edge of the flexible pouch 102. The flexible pouch 102 may include a bottom seam 111 that joins a bottom edge 103a of the front panel 103 to a bottom edge 105a of the back panel 105. In the alternative, the flexible pouch 102 does not have a bottom seam 111, e.g., the front panel 103 and the back panel 105 may be formed from a single piece of sheet material with a fold to produce a bottom edge. A gusset 132 (FIG. 4) may be included and sealed between the bottom edge 103a and bottom edge 105a, the gusset 132 facilitating the flexible pouch 102 being positioned and maintaining an upright position.

The spray fitment assembly 104 may be attached to and positioned between a top edge 103b of the front panel 103 and a top edge 105b of the back panel 105. In embodiments, the spray fitment assembly 104 includes a base 118 attached or sealed to the top edge 103b of the front panel 103 and top edge 105b of the back panel 105 with an upper seam 115 extending along the top edge 103b, top edge 105b, and an outer surface of the base 118. The spray fitment assembly 104 may include a head 107 with a handle 108 and spray nozzle 109. The head 107 may securely attach to the base 118 as discussed in greater detail below. It is understood that the handle 108 can be used to pump product contained within the flexible pouch 102 through the spray fitment assembly 104 such that a spray of the product exits the spray nozzle 109. In embodiments, a tube 126 is included. The tube 126 may include an upper end 128 attached to the spray fitment assembly 104 and a lower end 130 proximate to the bottom edges 103a, of the flexible pouch 102. The tube 126 in combination with the handle 108 allows product located near a bottom portion of the flexible pouch 102 to be removed from the flexible pouch 102 and dispensed through the spray nozzle 109.

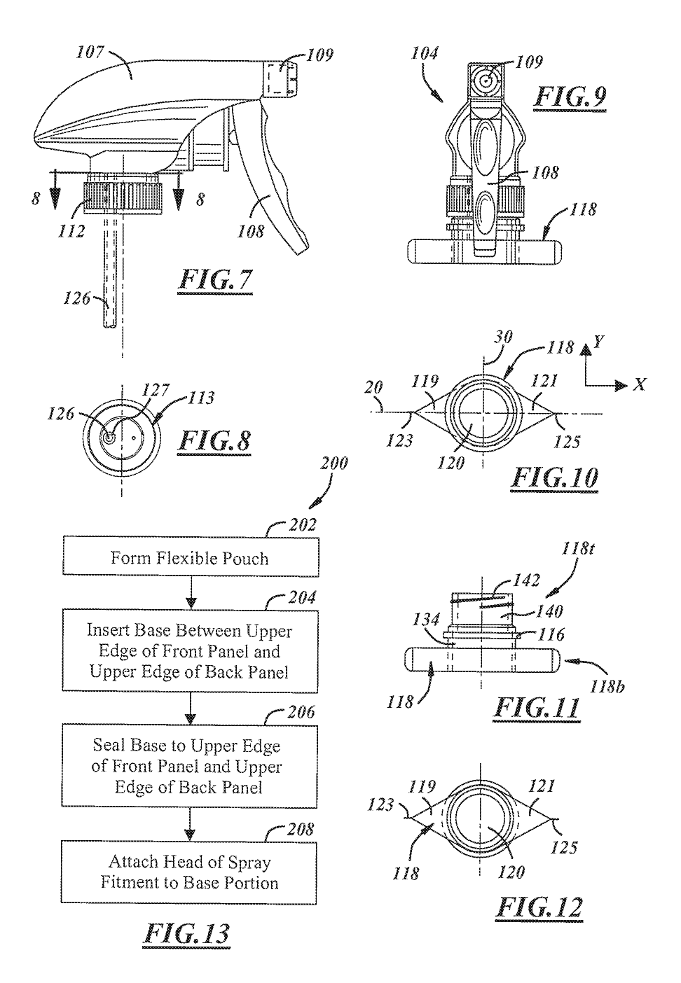

Referring now to FIGS. 7-9, the spray fitment assembly 104 with the head 107 may include a grip portion 112. The grip portion 112 may be positioned between a first annular portion 110 and a second annular portion 114 (FIG. 1). In embodiments, the grip portion 112 can freely rotate about the first annular portion 110 and have a hollow cylindrical portion 113 with an internal thread (not shown) helically wound within the hollow cylindrical portion 113. The head 107 may include an aperture 127 (FIG. 8) dimensioned for the tube 126 to attach to, e.g., the aperture 127 may be dimensioned to have an interference fit when the tube 126 is positioned at least partially within the aperture 127.

Referring to FIGS. 10-12, the spray fitment assembly 104 may include a base 118 with a bottom portion 118b and a top portion 118t. The bottom portion 118b may have a canoe shape with a length direction (X direction in FIG. 10) and a width direction (Y direction in FIG. 10). A longitudinal axis 20 extends along the length direction, a transverse axis 30 extends along the width direction and a length of the canoe-shaped bottom portion 118b is greater than a width of the canoe-shaped bottom portion 118b. The canoe-shaped bottom portion 118b may include a pair of oppositely disposed tip portions 119, 121 as shown in FIG. 10 and a pair of oppositely disposed finger portions 123, 125 extending from the tip portions 119, 121. The tip portions 119, 121 and the finger portions 123, 125 facilitate a smooth transition or connection between the canoe-shaped bottom portion 118b and the upper seam 115. In embodiments, the upper seam 115 is a heat seam, i.e., a seam formed by heating the top edges 103b, 105b of the front panel 103 and back panel 105 such that the top edges 103b, 105b are melted and joined together. The finger portions 123, 125 may also be melted and fused with the top edges 103b, 105b within the upper seam 115. Accordingly, it is understood that the tip portions 119, 121 and finger portions 123, 125 facilitate forming a leak-tight seal between the canoe-shaped bottom portion 118b and the front panel 103 and back panel 105. That is, the canoe-shaped bottom portion 118b with the tip portions 119, 121 and finger portions 123, 125 help ensure a leak-tight flexible pouch container.

Referring to FIGS. 11 and 12, the top portion 118t has a tube portion 140 with an external thread 142 helically wound around the tube portion 140. The external thread 142 is complementary with the internal thread within the hollow cylindrical portion 113 of the head 107 such that the external thread and internal thread mate to from a leak-tight seal between the head 107 and base 118. An annular rib 116 may be formed on the tube portion 140 and assist with installation or placement of the canoe-shaped bottom portion 118b between the top edge 103b of the front panel 103 and top edge 105b of the back panel 105 during manufacture of the flexible pouch assembly 100.

In operation, the flexible pouch 102 contains a product in the interior 101, e.g., a cleaner or cleanser liquid, and activation of the handle 108 in a pumping fashion pumps the product from in the interior 101 of the flexible pouch 102 up through the tube 126, through the head 107 and out of the spray nozzle 109. In this manner, a product contained in the interior 101 of the flexible pouch 102 can be sprayed and applied at a desired location by an individual grasping and using the flexible pouch assembly 100.

A method for forming a flexible pouch assembly with a spray fitment assembly is also disclosed and described herein as depicted in FIG. 13 at reference numeral 200. The method includes forming a flexible pouch by joining a front panel to a back panel at step 202, the front panel and the back panel each having an upper edge. A base of a spray fitment assembly is inserted between the upper edge of the front panel and the upper edge of the back panel at step 204. The base is sealed to the front panel and the back panel with a top seam extending along the upper edge of the front panel, the upper edge of the back panel, and an outer surface of the base at step 206. The base has an aperture that provides a fluid passageway into an interior between the front panel and back panel and once the base is attached to the front panel and back panel the interior may be filled through the base with a product. A head of the spray fitment assembly is attached to the base portion at step 208. The head may include a grip portion with a hollow cylindrical portion that has an internal thread helically wound within the hollow cylindrical portion and the base may include a tube portion with an external thread helically wound around the tube portion. The external thread is complementary with the internal thread such that the threads mate during rotation of the head relative to the base and provide a secure leak-tight seal between the head and the base. In embodiments, the base has a bottom portion with a canoe shape. The canoe-shaped bottom portion has a length and a width that is less than the length. The canoe-shaped bottom portion also has oppositely disposed tip portions with finger portions extending from the tip portions. Sealing the base to the front panel and the back panel includes forming the top seam along the upper edge of the front panel, the upper edge of the back panel, and the finger portions of the canoe-shaped bottom portion.

Based on the foregoing, it should now be understood that a flexible pouch assembly with a spray fitment may be used for storage, transportation, and dispensing of desired products such as cleaners, cleansers, etc. The flexible pouch assembly allows for the spraying of the product onto a desired location via a spray fitment and more efficient storage and/or transportation of the product as the flexible pouch assembly occupies less volume as the product within the flexible pouch is removed, i.e., sprayed from the flexible pouch.

While specific reference has been made herein to a flexible pouch assembly for the use of cleaners, cleansers, etc., it should be understood that any product suitable for containment within a flexible pouch is included in the embodiment shown and described herein.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modifications and variations come within the scope of the appended claims and their equivalents.

What is claimed is:

1. A flexible pouch assembly comprising:
a flexible pouch having a front panel, a back panel and an interior for holding a product between the front panel and the back panel, each of the front panel and the back panel having an upper edge;
a spray fitment assembly comprising a base and a head, the base having a bottom portion, a top portion and an aperture extending through the bottom portion and the top portion, the bottom portion sealed between the upper edge of the front panel and the upper edge of the back panel, the top portion having a tube portion with an external thread helically wound around the tube portion;
the head having a hollow cylindrical portion with an internal thread complementary with the external thread of the tube portion helically wound within the hollow cylindrical portion,
wherein the external thread of the top portion and the internal thread of the hollow cylindrical portion mate to form a leak-tight seal between the base and the head of the spray fitment assembly, the flexible pouch and spray fitment assembly configured to flow product from within the interior of the flexible pouch into the head and be sprayed from the flexible pouch assembly through the spray fitment assembly.

2. The flexible pouch assembly of claim 1, wherein the bottom portion of the base has a canoe shape with a longitudinal axis extending along a length direction of the bottom portion and a transverse axis extending along a width direction of the bottom portion, the bottom portion having a pair of tip portions oppositely disposed about the transverse axis and extending along the longitudinal axis and a finger portion extending from each of the pair of tip portions with a top seam extending along each of the finger portions.

3. The flexible pouch assembly of claim 2, further comprising a tube extending from the head through the aperture in the base and into the interior of the flexible pouch.

4. The flexible pouch assembly of claim 3, wherein the tube extends from the head to a bottom portion of the interior of the flexible pouch.

5. The flexible pouch assembly of claim 4, wherein the head further comprises a handle and a spray nozzle, wherein the handle is configured to pump product from the interior of the flexible pouch through the tube and out of the spray nozzle.

6. A method for forming a flexible pouch assembly comprising:
forming a flexible pouch with an interior for holding product between a front panel and a back panel, the front panel and the back panel each having an upper edge;
inserting a base of a spray fitment assembly between the upper edge of the front panel and the upper edge of the back panel;
sealing the base to the front panel and the back panel with a seam extending along the upper edge of the front panel, the upper edge of the back panel and an outer surface of the base; and
attaching a head of the spray fitment assembly to the base.

7. The method of claim 6, wherein the base of the spray fitment assembly comprises a bottom portion and a top portion and the seam extends along the upper edge of the front panel, the upper edge of the back panel and an outer surface of the bottom portion.

8. The method of claim 7, wherein the bottom portion of the base comprises:
a canoe shape with a longitudinal axis extending along a length direction of the bottom portion and a transverse axis extending along a width direction of the bottom portion;
a pair of tip portions oppositely disposed about the transverse axis and extending along the longitudinal axis; and
a finger portion extending from each of the pair of tip portions;
wherein the seam extends along the upper edge of the front panel, the upper edge of the back panel the finger portion extending from each of the pair of tip portions.

9. The method of claim 7, wherein the top portion of the base has a tube portion with an external thread helically wound around the tube portion and the head of the spray fitment assembly has a hollow cylindrical portion with an internal thread complementary with the external thread element helically wound within the hollow cylindrical portion; and
the external thread of the base mates with the internal thread of the head to form a leak-tight seal between the base and the head such that product flows from within the interior of the flexible pouch into the head and is sprayed through the spray fitment assembly.

10. The method of claim 6, further comprising attaching a tube to the base of the spray fitment assembly, the tube extending from the head into the flexible pouch.

11. The method of claim 10, wherein the head comprises a handle and a spray nozzle and actuation of the handle pumps product in the interior of the flexible pouch through the tube and through the spray nozzle.

12. The method of claim 6, further comprising filling the interior of the flexible pouch with product through aperture in the base.
